(19) United States
(12) Patent Application Publication
(10) Pub. No.: US 2025/0258269 A1
(43) Pub. Date: Aug. 14, 2025

(54) METHOD AND SYSTEM FOR CALCULATING AND ASSIGNING USE COORDINATES TO STATIONARY RADIO TRANSCEIVERS OF A LOCALIZATION SYSTEM

(71) Applicants: TRUMPF TRACKING TECHNOLOGIES GMBH, Ditzingen (DE); ZIGPOS GMBH, Dresden (DE)

(72) Inventors: Franz Lehmann, Dresden (DE); Richard Weber, Dresden (DE)

(21) Appl. No.: 19/193,981

(22) Filed: Apr. 30, 2025

Related U.S. Application Data
(63) Continuation of application No. PCT/EP2023/079655, filed on Oct. 24, 2023.

(30) Foreign Application Priority Data
Nov. 2, 2022 (DE) 10 2022 128 971.0

(51) Int. Cl. G01S 5/02

(52) U.S. Cl. CPC G01S 5/0289; G01S 5/02522

(57) ABSTRACT

A method calculates and assigns use coordinates to stationary radio transceivers of a localization system. The localization system includes a plurality of the stationary radio transceivers. The localization system determines multiple first relative location references between the radio transceivers. The method includes: providing additional information including multiple planar coordinates; and calculating and assigning the use coordinates for each of the stationary radio transceivers based on the additional information and the first relative location references.

### CROSS REFERENCE TO RELATED APPLICATIONS

This application is a continuation of International Application No. PCT/EP2023/079655 (WO 2024/094498 A1), filed on Oct. 24, 2023, and claims benefit to German Patent Application No. DE 10 2022 128 971.0, filed on Nov. 2, 2022. The aforementioned applications are hereby incorporated by reference herein.

### FIELD

The invention relates to a method and device for calculating and assigning use coordinates to stationary radio transceivers of a localization system. The invention further relates to a system for calculating and assigning use coordinates to stationary radio transceivers of a localization system.

### BACKGROUND

From DE102018110145A, an indoor tracking system with spatially fixed transmitting/receiving units and mobile transmitting/receiving units is known.

Localization systems are based on the calculation of distances and/or angles to spatial points with known coordinates. Spatial points with known coordinates are typically stationary radio transceivers, also called anchors. When setting up the localization system, it may therefore be necessary to determine the coordinates of the anchors.

### SUMMARY

In an embodiment, the present disclosure provides a method for calculating and assigning use coordinates to stationary radio transceivers of a localization system. The localization system includes a plurality of the stationary radio transceivers. The localization system determines multiple first relative location references between the radio transceivers. The method includes: providing additional information including multiple planar coordinates; and calculating and assigning the use coordinates for each of the stationary radio transceivers based on the additional information and the first relative location references.

### BRIEF DESCRIPTION OF THE DRAWINGS

Subject matter of the present disclosure will be described in even greater detail below based on the exemplary figures. All features described and/or illustrated herein can be used alone or combined in different combinations. The features and advantages of various embodiments will become apparent by reading the following detailed description with reference to the attached drawings, which illustrate the following:

FIG. 1a shows a schematic representation of stationary radio transceivers and relative first location references between the radio transceivers according to an embodiment of the present invention;

FIG. 1b shows a further schematic representation of stationary radio transceivers and relative first location references between the radio transceivers according to an embodiment of the present invention;

FIG. 2 shows a schematic representation of a reference map with planar coordinates according to an embodiment of the present invention;

FIG. 3 shows a schematic representation of a control map according to an embodiment of the present invention;

FIG. 4 shows a schematic representation of the determination of a position of a mobile radio transceiver according to an embodiment of the present invention;

FIG. 5 shows a schematic representation of the use of a mobile radio transmitter to improve the use coordinates according to an embodiment of the present invention; and

FIG. 6 shows a flow chart according to an embodiment of the present invention.

### DETAILED DESCRIPTION

Embodiments of the present invention simplify the determination of the coordinates of the anchors.

Embodiments of the present invention can so by a method for calculating and assigning use coordinates to stationary radio transceivers of a localization system, wherein the localization system comprises a plurality of stationary radio transceivers, wherein the localization system determines multiple first relative location references between the radio transceivers, in particular embodiments by means of ultra-wideband radio technology, wherein additional information is provided, wherein the additional information includes multiple planar coordinates, wherein use coordinates are calculated and assigned for each of the stationary radio transceivers by means of the additional information and the first relative location references.

The relative first location references can be determined as distances and/or angles. The distance between two stationary radio transmitters can be determined, for example, by a travel time measurement of radio signals between the stationary radio transmitters. Very accurate distance measurement is possible, particularly when using ultra-wideband radio technology. Alternatively or in addition to the distance, reception angles of radio signals can be determined. A stationary radio transmitter with multiple antennas or an antenna array can determine the angle from which a radio signal is received.

From the first relative location references, a map can be created, for example by means of trilateration and/or triangulation, which indicates the positions of the stationary radio transmitters in relation to each other. A map created in this way can be unambiguous or ambiguous.

Planar coordinates indicate coordinates at which stationary radio transmitters are preferably present. Planar coordinates can remain unoccupied. Likewise, stationary radio transmitters can be present at other coordinates that are not planar coordinates. In preferred embodiments, a plurality of the stationary radio transmitters are substantially each present at one of the planar coordinates.

Based on the planar coordinates, the use coordinates of the stationary radio transceivers can be calculated and the use coordinates can be assigned to the stationary radio transceivers.

The use coordinates are the coordinates assigned to the stationary radio transceivers that are used when using the localization system. Based on the use coordinates of the stationary radio transceivers, positions of mobile radio transceivers can be determined.

The planar coordinates are, in a preferred embodiment, taken from a reference map. The reference map shows the planned positions of the stationary radio transmitters. Other objects such as walls, for example, can be recorded in the reference map. The planar coordinates are thus directly related to surrounding objects. In a preferred embodiment, at least one wall is recorded in the reference map and the wall is extracted from the reference map by means of image processing, wherein the wall is taken into account in the calculation and assignment of the use coordinates. Reflections of the radio signals on the wall can thus be taken into account.

In one embodiment, a graphical user interface is provided for entering the planar coordinates into the reference map. When entered into a digital map, the positions can be used directly as planar coordinates.

In an alternative embodiment, the planar coordinates are extracted from the reference map using image processing. The planar coordinates can, for example, be noted in the form of predetermined symbols in the reference map, so that the predetermined symbols are recognized by means of image processing and their position in the map is determined. This makes it very easy to determine the planar coordinates from a human-readable representation.

In a further embodiment, the planar coordinates originate from a previous installation of the localization system. The procedure then checks whether the stationary radio transmitters have remained in their old positions. The set-up of the localization system can be checked and corrected very easily in this way. A warning is, in a preferred embodiment, issued if the use coordinates deviate from the planar coordinates by more than a predetermined threshold value. The warning informs the user that the use coordinates do not match the planar coordinates and that, consequently, the set-up of the localization system has changed. This can happen, for example, if stationary radio transceivers have been relocated.

In a preferred embodiment, the use coordinates are calculated such that second relative location references between the use coordinates substantially correspond to the first relative location references. This substantially means that the measured first relative location references have measurement uncertainties. It may therefore be impossible to fulfill all the first relative location references perfectly. In this case, the use coordinates are calculated in such a way that the deviation is optimized as far as possible for the application. Deviations may be weighted with the measurement uncertainties if necessary, i.e., if the measurement uncertainty is large, a larger deviation is tolerated than if the measurement uncertainty is small.

In a further preferred embodiment, the use coordinates are calculated for a plurality of the stationary radio transmitters such that differences between the respective use coordinates and the respective nearest planar coordinates are minimized. In other words, the use coordinates are calculated such that as many use coordinates as possible are as close as possible to planar coordinates. The procedure thus ensures that the use coordinates correspond as closely as possible to the planar coordinates.

In a particularly preferred embodiment, the differences between the first and second relative location references and between the respective use coordinates and the respective nearest planar coordinates are simultaneously minimized. The calculated usage data then forms a compromise between the best possible reproduction of the first relative location references and the approximation to the planar coordinates.

In a preferred embodiment, the differences between the respective use coordinates and the respective nearest planar coordinates and/or the first and second relative location relationships are minimized according to a linear or quadratic metric, and in particular embodiments, the metric of the least error squares.

In a preferred embodiment, at least one of the planar coordinates is assigned to one of the stationary radio transceivers. For this stationary radio transceiver, the difference between the use coordinates and the assigned planar coordinates is minimized. The assigned planar coordinate is not necessarily the closest planar coordinate.

In a preferred embodiment, the use coordinates are visualized in a control map. The control map can be based on the reference map. The visualization enables a very easy control of the calculated and assigned use coordinates. In a particularly preferred embodiment, the planar coordinates are visualized in addition to the use coordinates. This makes it easy to check the deviation of the use coordinates from the planar coordinates.

In a further preferred embodiment, at least one of the stationary radio transceivers outputs an acoustic or visual signal and the use coordinates of the signal-outputting stationary radio transceiver are visualized on the control map. In a preferred embodiment, a stationary radio transceiver can be selected and triggered to output a signal by means of a user interface.

In a preferred embodiment, a mobile radio transceiver is moved in an environment of the stationary radio transmitters, wherein third relative location references between the stationary radio transmitters and the mobile radio transmitter are determined, wherein the third relative location references are taken into account when calculating the use coordinates. How the third relative location references can be used is known from the dissertation “Automatisierte Integration von funkbasierten Sensornetzen auf Basis simultaner Lokalisierung und Kartenerstellung” [“Automated integration of radio-based sensor networks based on simultaneous localization and mapping”] by Richard Weber, which can be accessed at https://nbn-resolving.org/urn:nbn:de:bsz:14-qucosa2-752459. The contents of the dissertation are hereby incorporated in their entirety by reference.

Embodiments of the present invention can further comprise a system for calculating and assigning use coordinates to stationary radio transceivers of a localization system, wherein the system comprises a plurality of stationary radio transceivers and a computing unit, wherein the computing unit is communicatively coupled to the stationary radio transceivers, wherein the computing unit has at least one interface for reading additional information, wherein the computing unit is provided and configured to carry out a method as described above.

In a preferred embodiment, the interface is a user interface, and in particular embodiments, a graphical user interface. The user interface can be used, for example, to enter planar coordinates or to output maps such as a reference map or a control map.

In a preferred embodiment, the interface is connected to a memory, wherein planar coordinates, and in particular embodiments in the form of a reference map, are stored in the memory.

Furthermore, embodiments of the present invention can comprise a computer program product, wherein the computer program product can be loaded directly into the internal memory of a digital computer and comprises software sections with which the steps according to a method according to an embodiment of the present invention are carried out when the computer program product is executed on the computer.

In a preferred embodiment, the computer program product is stored in a memory, and in particular embodiments a non-volatile memory.

The following description of preferred embodiments serves to explain embodiments of the present invention in greater detail with reference to the drawings.

Elements that are the same or have equivalent functions are provided with the same reference signs in all of the figures.

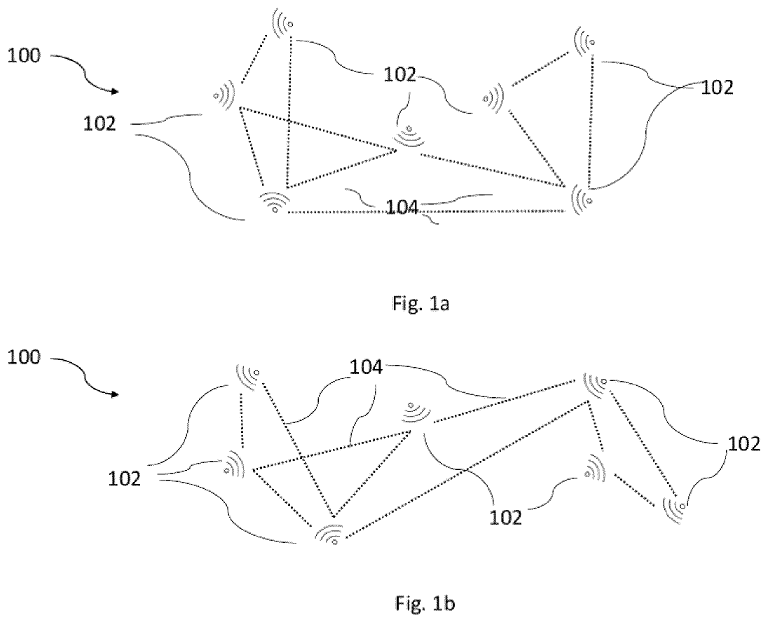

FIGS. 1a and 1b show a localization system 100 with a plurality of stationary radio transceivers 102. The stationary radio transceivers 102 are configured to send and receive radio signals and to determine distances between the radio transceivers from the travel time of the radio signals between the radio transceivers 102. In a variant, reception angles of the radio signals can be determined instead of the distances or in addition to the distances. It is possible to determine an angle, for example, using multiple receiving antennas on a radio transceiver or an antenna array. Distances and/or angles are referred to as the first relative location relationship 104.

Based on the first relative location relationships 104 between the stationary radio transceivers 102, the relative positions of the stationary radio transceivers to each other can be determined. FIGS. 1a and 1b show two possible relative positions of the stationary radio transceivers 102 with identical first relative location relationships 104. Whether clear relative positions of the stationary radio transceivers 102 can be determined from the first relative location relationships 104 between the stationary radio transceivers 102 depends on the individual case.

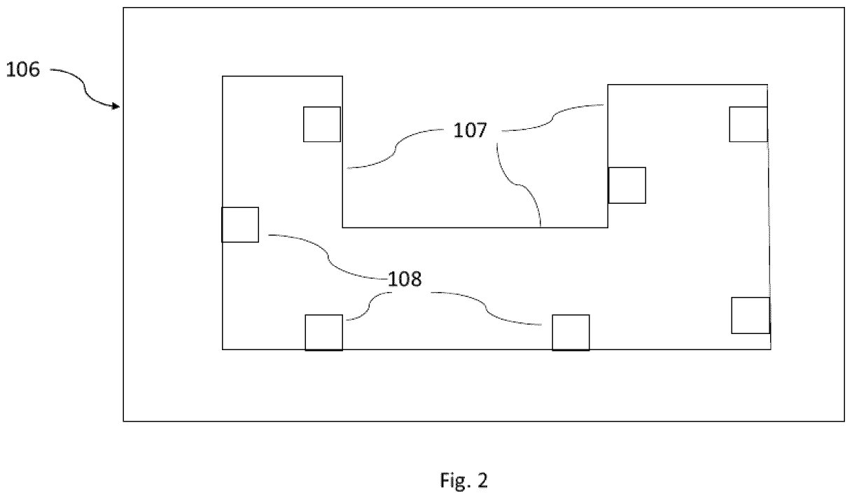

A reference map 106 is shown in FIG. 2. The reference map 106 shows walls 107 and planar coordinates 108. For reasons of clarity, not all walls 107 and not all planar coordinates 108 are provided with reference symbols. The planar coordinates 108 indicate where stationary radio transceivers are to be expected relative to the walls 107. The reference map 106 can be in the form of a digital image, for example as a pixel representation or as a vector graphic. By means of image processing, the coordinates of the planar coordinates 108 and the walls 107 can be extracted from the digital image.

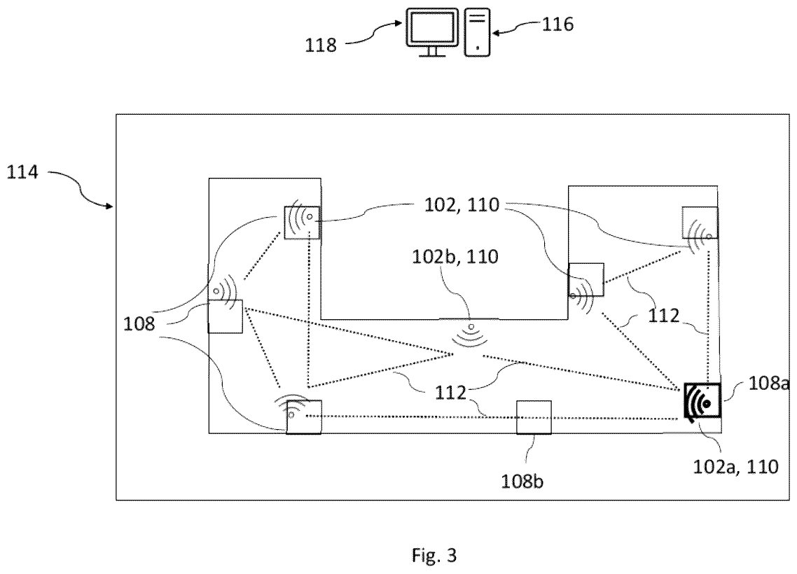

A control map 114 is shown in FIG. 3. The control map 114 shows the use coordinates 110 of the stationary radio transceivers 102 together with the walls 107 and the planar coordinates 108. In addition, second relative location relationships 112 between the use coordinates 110 are shown. For reasons of clarity, not all second relative location relationships 112, planar coordinates 108 and use coordinates 110 are provided with reference symbols. It can be seen that the use coordinates 110 do not match the planar coordinates 108. The use coordinates 110 were calculated in such a way that the differences of as many use coordinates 110 as possible to one respective planar coordinate 108 were minimized and at the same time the difference between the second relative location relationships 112 and the first relative location relationships 104 is minimized. In a perfect case, all differences would disappear. In most cases, as in this example, the differences will have to be minimized according to a suitable metric, here the metric of the smallest error squares.

The calculation of the use coordinates 110 from the first relative location relationships 104 and the planar coordinates 108 is carried out by a computing unit 116. The computing unit 116 receives the first relative location relationships 104 and the planar coordinates 108, for example in the form of the reference map 106 from FIG. 2, and calculates the use coordinates 110 of the stationary radio transceiver 102. The use coordinates 110 are output by the computing unit 116 via an output device 118, for example in the form of a control map 114. It is understood that the use coordinates 110 can also be output to another computing unit. Alternatively or additionally, the use coordinates 110 can be stored in a memory and subsequently used by the computing unit 116, for example when executing an application that requires the use coordinates.

In this example, the output device 118 is a touchscreen via which the computing unit 116 can display a graphical user interface and accept inputs. Using the graphical user interface, a user can, for example, enter or change planar coordinates. Alternatively or additionally, the user can use the user interface to select stationary radio transceivers 102 that are to output an acoustic or visual signal. The use coordinates 110 of the stationary radio transceiver which has output a signal are then visualized via the output device 118.

A specific planar coordinate 108a is assigned to a specific stationary radio transceiver 102a. For this radio transceiver 102a, the difference between the use coordinate 110 and the associated planar coordinate 108a is minimized and no further planar coordinates are taken into account.

In this example, the difference between the use coordinates 110 and the respective nearest planar coordinates 108 is minimized for six of the seven stationary radio transceivers 102. The use coordinate 110 of a stationary radio transceiver 102b is so far away from all planar coordinates that the difference between the coordinates is not minimized. Instead, it is assumed that this stationary radio transceiver 102b was installed at a different location from the planar coordinates.

In this example, a planar coordinate 108b is so far away from the use coordinates 110 of the stationary radio transceivers 102 that it is assumed that no radio transceiver is present at this planar coordinate 108b.

It is a coincidence that the number of planar coordinates 108 and use coordinates 110 are identical in this example. In general, there may be more or fewer planar coordinates 108 than use coordinates 110.

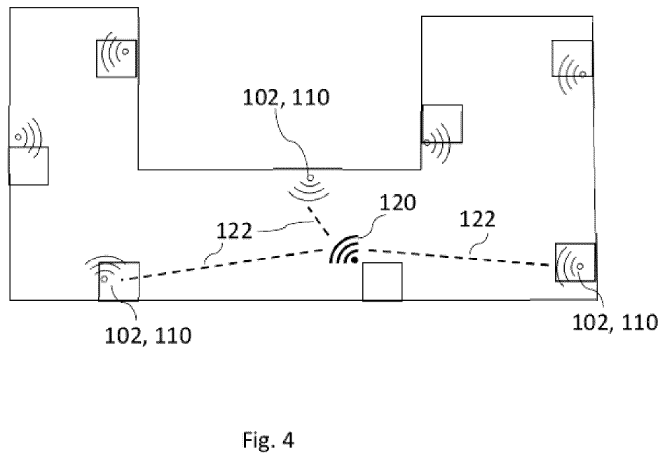

FIG. 4 shows how the position of a mobile radio transceiver 120 is determined based on the use coordinates 110 of the stationary radio transceiver 102. The stationary radio transceiver 102 and the mobile radio transceiver 120 exchange radio signals, here ultra-wideband pulses, and measure the travel times of the radio signals. From the travel times of the radio signals, third relative location references 122 are determined between the stationary radio transceivers 102 and the mobile radio transceiver 120. The position of the mobile radio transceiver 120 is determined from the use coordinates 110 of the stationary radio transceiver 102 and the third relative location references 122.

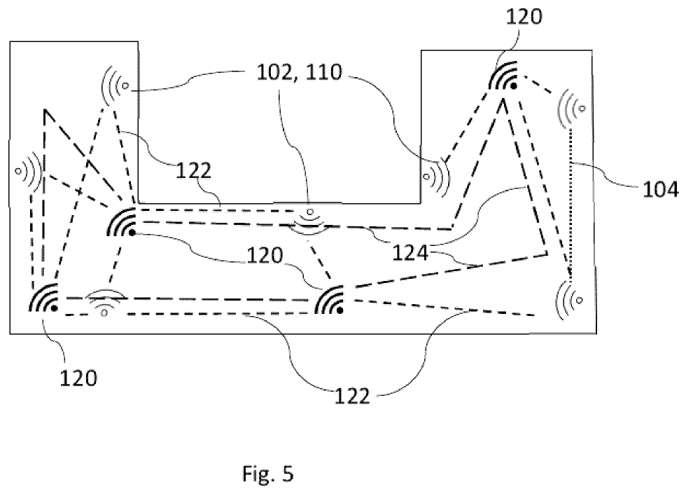

FIG. 5 shows that a mobile radio transceiver 120 is moved along a trajectory 124. During the movement of the mobile radio transceiver 120, multiple third relative location references 122 are determined between the mobile radio transceiver 120 and the stationary radio transceivers. The third relative location references thus obtained are offset against the first relative location references 104 and thus enable the calculation of the use coordinates 110 to be improved.

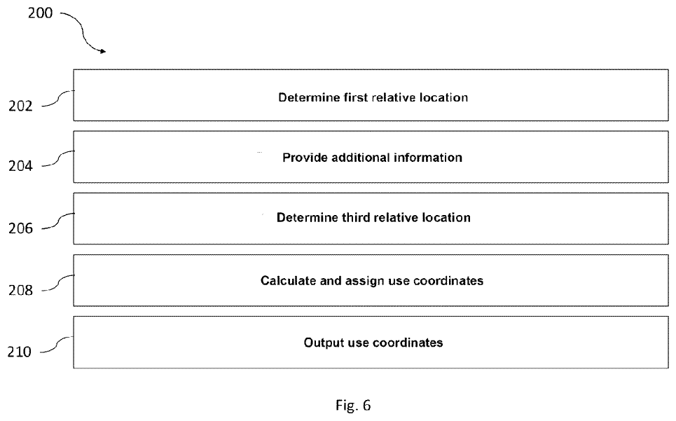

A flow chart 200 is shown in FIG. 6. In a first step 202, first relative location references 104 are determined between the stationary radio transceivers 102. In a second step 204, additional information is provided. The additional information contains at least multiple planar coordinates. In an optional third step 206, third relative location references 122 are determined between the stationary radio transceivers 102 and a mobile radio transceiver 120. In a fourth step 208, use coordinates 110 for the stationary radio transceivers 102 are determined and assigned to them. The use coordinates 110 are output in an optional fifth step 210.

While subject matter of the present disclosure has been illustrated and described in detail in the drawings and foregoing description, such illustration and description are to be considered illustrative or exemplary and not restrictive. Any statement made herein characterizing the invention is also to be considered illustrative or exemplary and not restrictive as the invention is defined by the claims. It will be understood that changes and modifications may be made, by those of ordinary skill in the art, within the scope of the following claims, which may include any combination of features from different embodiments described above.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE SYMBOLS

100 Localization system
102 Stationary radio transceiver
104 First relative location references
106 Reference map
108 Planar coordinates
110 Use coordinates
112 Second relative location references
114 Control map
116 Computing unit
118 Output device
120 Mobile radio transceiver
122 Third relative location references
124 Trajectory
200 Flow chart
202 First step
204 Second step
206 Third step
208 Fourth step
210 Fifth step

What is claimed is:

1. A method for calculating and assigning use coordinates to stationary radio transceivers of a localization system, wherein the localization system comprises a plurality of the stationary radio transceivers, wherein the localization system determines multiple first relative location references between the radio transceivers, the method comprising:
providing additional information comprising multiple planar coordinates; and
calculating and assigning the use coordinates for each of the stationary radio transceivers based on the additional information and the first relative location references.

2. The method according to claim 1, wherein the multiple planar coordinates are taken from a reference map.

3. The method according to claim 2, wherein a graphical user interface is provided for entering the multiple planar coordinates into the reference map.

4. The method according to claim 2, wherein the multiple planar coordinates are extracted from the reference map based on image processing.

5. The method according to claim 4, wherein at least one wall is recorded in the reference map and the wall is extracted from the reference map based on the image processing, wherein the wall is taken into account in the calculation and assignment of the use coordinates.

6. The method according to claim 1, wherein the multiple planar coordinates originate from a previous installation of the localization system.

7. The method according to claim 6, wherein a warning is issued if the use coordinates deviate from the multiple planar coordinates by more than a predetermined threshold value.

8. The method according to claim 1, wherein the use coordinates are calculated such that second relative location references between the use coordinates substantially correspond to the first relative location references.

9. The method according to claim 1, wherein the use coordinates are calculated for a plurality of the stationary radio transmitters such that differences between the respective use coordinates and respective closest planar coordinates are minimized.

10. The method according to claim 8, wherein differences between respective use coordinates and respective nearest planar coordinates and/or the first relative location references and the second relative location relationships are minimized according to a linear or quadratic metric.

11. The method according to claim 1, wherein at least one of the multiple planar coordinates is assigned to one of the plurality of stationary radio transceivers.

12. The method according to claim 1, wherein the use coordinates are visualized in a control map.

13. The method according to claim 1, wherein at least one of the plurality of stationary radio transceivers outputs an acoustic or visual signal and the use coordinates of the signal-outputting stationary radio transceiver are visualized on a control map.

14. A system for calculating and assigning use coordinates to stationary radio transceivers of the localization system, wherein the system comprises a plurality of stationary radio transceivers and a computing unit, wherein the computing unit is communicatively coupled to the plurality of stationary radio transceivers, wherein the computing unit has at least one interface for reading the additional information, and wherein the computing unit is provided and configured to carry out the method according to claim 1.

15. The system according to claim 14, wherein the at least one interface comprises a user interface.

16. The system according to claim 14, wherein the at least one interface is connected to a memory, wherein planar coordinates in the form of a reference map are stored in the memory.

17. A non-transitory computer readable medium, wherein the non-transitory computer readable medium can be loaded directly into an internal memory of a digital computer and comprises software sections with which the steps according to the method of claim 1 are carried out when the non-transitory computer readable medium is executed on the digital computer.

18. The method according to claim 1, wherein the localization system determines the multiple first relative location references between the radio transceivers based on ultra-wideband radio technology.

19. The method according to claim 10, wherein the linear or quadratic metric is a metric of the least error squares.

20. The system according to claim 15, wherein the user interface is a graphical user interface.
